(19) United States
(12) Patent Application Publication
(10) Pub. No.: US 2014/0040762 A1
(43) Pub. Date: Feb. 6, 2014

(54) SHARING A DIGITAL OBJECT

(71) Applicants: Alexander Friedrich KUSCHER, San Francisco, CA (US); Trond Thomas Wuellner, Mountain View, CA (US)

(72) Inventors: Alexander Friedrich KUSCHER, San Francisco, CA (US); Trond Thomas Wuellner, Mountain View, CA (US)

(73) Assignee: Google Inc., Mountain View, CA (US)

(21) Appl. No.: 13/564,593

(22) Filed: Aug. 1, 2012

(51) Int. Cl. G06F 3/01

(52) U.S. Cl. 715/748

(57) ABSTRACT

A system and method for sharing a digital object on a device with another device or service. A user request to associate at least one edge region of a display on a device with another device or service is received. In response to the request, the at least one edge region of the display on the device is associated with the other device or service. An input gesture comprising a movement from a first location on the display towards the at least one edge region of the display is received. A digital object associated with the first location is sent to the other device or service in response to the input gesture.

### BACKGROUND

The present disclosure generally relates to sharing a digital object, and, in particular, to sharing a digital object on a device with another device or service.

Computer users may seek to share data between their computing devices or services. For example, a user at a desktop computer reading a web page may desire to continue reading the web page on the user's smartphone. As another example, the user may want to save an image from the web page to an online data storage service.

### SUMMARY

The disclosed subject matter relates to computer-implemented method for sharing a digital object on a device with another device or service. The method includes receiving a user request to associate at least one edge region of a display on a device with another device or service, and associating, in response to the request, the at least one edge region of the display on the device with the other device or service. The method further includes receiving an input gesture comprising a movement from a first location on the display towards the at least one edge region of the display, and providing for sending a digital object associated with the first location to the other device or service in response to the input gesture.

The disclosed subject matter further relates to system for sharing a digital object on a device with another device or service. The system includes one or more processors, and a machine-readable medium comprising instructions stored therein, which when executed by the processors, cause the processors to perform operations comprising associating at least one edge region of a display on a device with another device or service. The operations further comprise receiving an input gesture comprising a movement from a first location on the display towards the at least one edge region of the display, and providing for sending a digital object associated with the first location to the other device or service in response to the input gesture.

The disclosed subject matter also relates to a machine-readable medium machine-readable medium comprising instructions stored therein, which when executed by a system, cause the system to perform operations comprising receiving a user request to associate at least one edge region of a display on a device with another device or service, wherein the edge region comprises an edge of the display or a corner of the display. The operations further comprise associating, in response to the request, the at least one edge region of the display on the device with the other device or service, and receiving an input gesture comprising a movement from a first location on the display towards the at least one edge region of the display. In addition, the operations comprise providing for sending a digital object associated with the first location to the other device or service in response to the input gesture.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example distributed network environment which can provide for sharing a digital object between devices.

FIG. 2 illustrates an example of a device in which different edge regions are associated with different devices for sharing a digital object.

FIG. 3 illustrates an example process by which a digital object on a device is shared with another device or service.

FIG. 4 illustrates an example process by which a digital object on a device is shared with another device or service via a server.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As noted above, computer users often seek to share data between their computing devices or services. For example, a user at a desktop computer reading a web page may desire to continue reading the web page on the user's smartphone. As another example, the user may want to save an image from the web page to an online data storage service. In order for a user to share data on a source device, the user often must take several steps in order to have the data successfully delivered from the source device to a target device or service. For example, in order to send the web page on the desktop computer to the smartphone, the user may: (1) open an email program, (2) compose a new email, (3) copy the address of the web page from the web browser displaying the web page, (4) paste the address of the web page into the email, (5) designate an email account on the smartphone as the destination, and (6) submit the email for transmission.

In order to save the image to the online data storage server, the user may: (1) save the image to the desktop computer, (2) load a web page for the online data storage service, (3) activate an interface on the web page for the online data storage service for uploading a file for storage, (4) select the saved image file, and (5) submit the image file to be uploaded to the online data storage service using the interface. As such, sharing data with another device or service is often a time consuming and lengthy procedure.

The subject disclosure allows a user to designate specific regions along the edge of a display screen of a device as being associated with other devices or services, such that when the user “flicks” (e.g., selects a displayed digital object, and moves, such as by dragging, the selected object in a certain direction) a digital object (e.g., text, image, or file) in the direction of a specific edge region, the digital object is shared with the device or service associated with that specific edge region. For example, a user may designate, on a tablet computer, the top edge of the user's tablet display as being associated with an online data storage service, and designate the right edge of the user's tablet display as being associated with the user's smartphone. In a further example, to send a currently displayed web page for driving directions on the tablet to the smartphone, the user may flick the web page towards the right edge of the tablet display. In order to save an image of a destination from the web page to the online data storage server, the user may flick the image from the web page towards the top edge of the tablet display.

In example aspects, the digital object is sent to a server, and the server sends the digital object to the target device or service. Additionally, the target device or service may automatically perform an action on the digital object when received. The action can be designated by the server after the server processes the digital object. For example, when the smartphone receives a copy of the web page driving directions from the server, the smartphone can automatically load the destination into a navigation application on the smartphone.

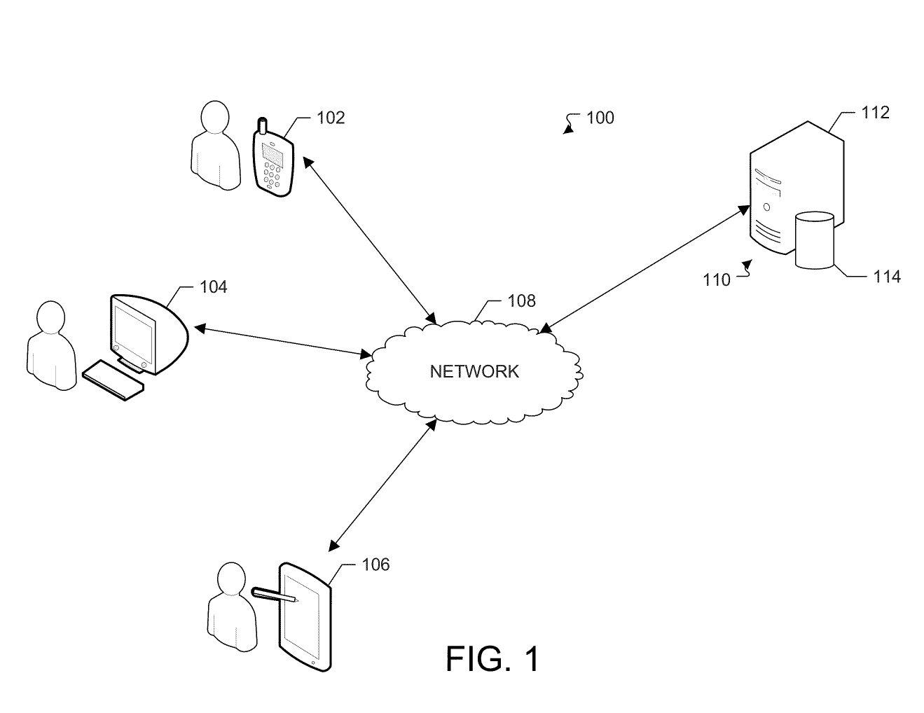

FIG. 1 illustrates an example distributed network environment which can provide for sharing a digital object between devices. A network environment 100 includes a number of electronic devices 102-106 communicably connected to a server 110 by a network 108. Server 110 includes a processing device 112 and a data store 114. Processing device 112 executes computer instructions stored in data store 114, for example, to host an application. Users may interact with the application, via network 108, using any one of electronic devices 102-106. Although FIG. 1 illustrates a client-server network environment 100, other aspects of the subject technology may include other configurations including, for example, peer-to-peer environments.

A digital object on an electronic device can be shared with another device or service. In the example of FIG. 1, a digital object can be shared between any of electronic devices 102-106. In one example, a digital object on electronic device 102 is shared with electronic device 104. Electronic device 102 receives a user request to associate at least one edge region of a display on electronic device 102 with electronic device 104. In response to the request, electronic device 102 associates the at least one edge region of the display on electronic device 102 device with electronic device 104. Electronic device 102 receives an input gesture (e.g., flick or other user input) comprising a movement from a first location on the display towards the at least one edge region of the display. In response to the input gesture, electronic device 102 provides for sending a digital object (e.g., text, image or a file) associated with the first location to electronic device 104.

In example aspects, the sharing of the digital object between any of electronic devices 102-106 can occur via server 110. Using the above example of sharing a digital object between electronic device 102 and electronic device 104, electronic device 102 transmits the digital object associated with the first location to server 110. After receiving the digital object from electronic device 102, server 110 designates an action in association with the digital object. Server 110 sends the digital object and the associated action to electronic device 104. After receiving the digital object from sender 110, electronic device 104 can perform the action associated with the digital object.

Electronic devices 102-106 can be computing devices such as laptop or desktop computers, smartphones, PDAs, portable media players, tablet computers, or other appropriate computing devices. In the example of FIG. 1, electronic device 102 is depicted as a smartphone, electronic device 104 is depicted as a desktop computer, and electronic device 106 is depicted as a PDA.

In some example aspects, server 110 can be a single computing device such as a computer server. In other embodiments, server 110 can represent more than one computing device working together to perform the actions of a server computer (e.g., cloud computing). Examples of computing devices that may be used to implement server 110 include, but are not limited to, a web server, an application server, a proxy server, a network server, or a group of computing devices in a server farm.

Communication between any of electronic devices 102-106 and server 110 may be facilitated through a network (e.g., network 108). Network 108 can be a public communication network (e.g., the Internet, cellular data network, dialup modems over a telephone network) or a private communications network (e.g., private LAN, leased lines). Communications between any of electronic devices 102-106 and server 110 may be facilitated through a communication protocol such as Hypertext Transfer Protocol (HTTP). Other communication protocols may also be facilitated for some or all communication between any of electronic devices 102-106 and server 110, including for example, Extensible Messaging and Presence Protocol (XMPP) communication.

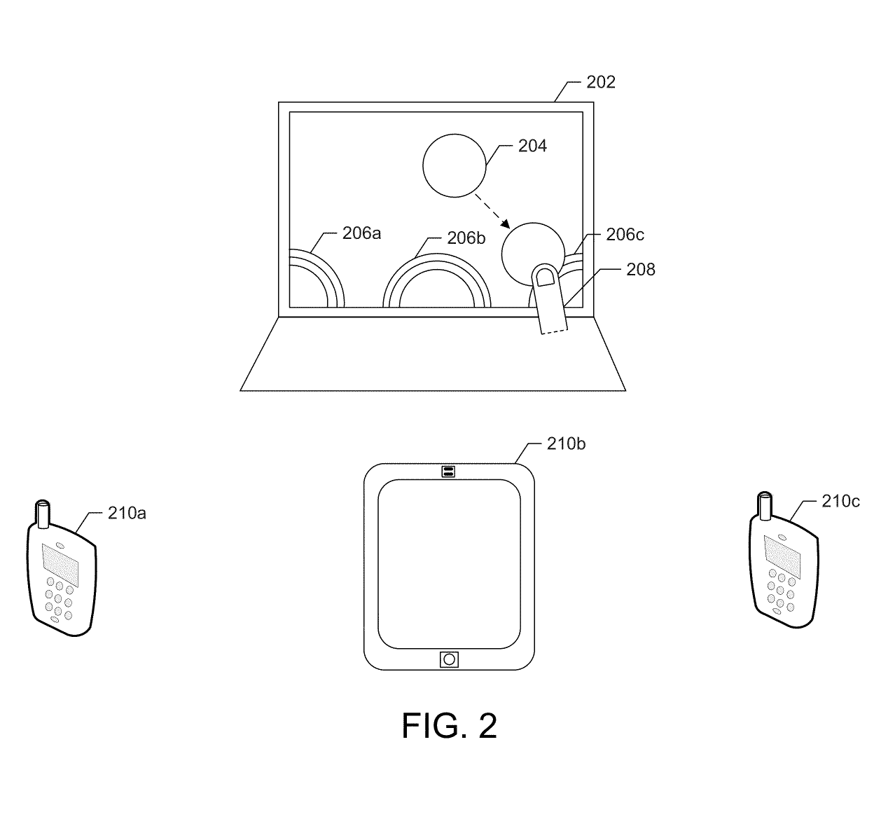

FIG. 2 illustrates an example of a device in which different edge regions are associated with different devices for sharing a digital object. In the example of FIG. 2, electronic device 202 shares a digital object 204 with any of electronic devices 210a, 210b or 210c. In example aspects, each of electronic devices 202 and 210a-210c can correspond to any of electronic devices 102-106 of FIG. 1.

In this regard, electronic devices 202 and 210a-210c can be computing devices such as laptop or desktop computers, smartphones, PDAs, portable media players, tablet computers, or other appropriate computing devices. In the example of FIG. 2, electronic device 202 is depicted as a laptop (e.g., including a touchscreen), electronic devices 210a and 210c are depicted as smartphones, and electronic device 210b is depicted as a tablet computer.

A user of electronic device 202 can request to associate one or more edge regions of the display of electronic device 202 with another device or service. For example, electronic device 202 can provide a graphical interface for enabling or disabling the association of edge regions of the display with the other devices or services.

The graphical interface can further provide the user with the ability to assign, position, size, activate or otherwise associate the edge regions with the other devices or services. In this regard, the graphical interface can provide for the user to define one or more “fling” zones, corresponding to edge regions associated with respective other devices. In example aspects, these fling zones can be locally stored on electronic device 202.

Based on the user's request, electronic device 202 associates the one or more edge regions of the display with the other devices or services. Electronic device 202 includes edge regions 206a, 206b and 206c, which are associated with electronic devices 210a, 210b and 210c, respectively. Each edge region can correspond to an edge of the display and/or a corner of the display. In the example of FIG. 2, edge region 206a corresponds to a lower-left corner of the display, edge region 206b corresponds to a central bottom edge of the display, and edge region 206c corresponds to a lower-right corner of the display.

The display can include a graphical component indicating the other device or service associated with each edge region. For example, the display of electronic device 202 can include, within each edge region, an icon, text and/or other type of graphical component which represents or identifies the device associated with that edge region. Alternatively, electronic device 202 may not display such a graphical component. For example, the user may designate and be aware of the assigned edge regions, and display of the associated devices within those edge regions may not be desired. A graphical user interface can be provided to the user, for enabling or disabling display of the associated devices.

In example aspects, the association of edge regions with other devices may be dynamic, in that the association is based on the position of the other devices. For example, electronic device 202 can rely on the positioning of the other devices (e.g., electronic devices 210a-210c) to define which edge region is associated with which device. It is possible for each edge region (e.g., edge regions 206a-206c) to be associated with target devices (e.g., electronic devices 210a-210c) based on the positioning of the target devices (e.g., electronic devices 210a-210c) relative to the source device (e.g., electronic device 202).

For example, electronic device 210a can be associated with edge region 206a based on its position relative to electronic device 202a. More specifically, since electronic device 210a is positioned in a direction which is below and to the left of electronic device 202, lower-left edge region 206a can be defined to be associated with electronic device 210a. In a similar manner, electronic device 210b can be associated with edge region 206b and electronic device 210c can be associated with edge region 206c based on their relative positions.

Furthermore, if any of electronic devices 210a-210c are physically repositioned relative to electronic device 202, edge regions 206a-206c can be adjusted accordingly, so as to match the new positions of electronic devices 210a-210c. For example, each of edge regions 206a-206c can be updated to one or more of an upper-left region, a central upper region, an upper-right region, a central left region, a central right region, a lower-left region, a central lower region or a right-lower region, depending on the repositioning of electronic devices 210a-210c.

The positioning of electronic devices 210a-210c relative to electronic device 202 can be detected in a variety of different manners. For example, one more of global positioning system (GPS), cell tower triangulation and Wi-Fi triangulation can be used to determine the position of electronic devices 210a-210c relative to electronic device 202. Alternatively, or in addition, relative positioning information can be manually defined by the user, for example, through a graphical interface within the display of electronic device 202. Alternatively, or in addition, relative positioning information can be detected using sensors or other interfaces within each device, such as, but not limited to, an accelerometer, a compass, a near field communication (NFC) interface, or a Bluetooth interface.

Electronic device 202 can receive an input gesture (e.g., from the user) in the form of a movement from a first location on the display towards one of the one or more associated edge regions 206a-206c. The input gesture can include at least one of a touch input, a mouse input or a keyboard input. For example, the input gesture can be a flick of the digital object, where the user selects the digital object, and moves (e.g., drags) the selected object in a certain direction.

In the example of FIG. 2, the input gesture corresponds to a touch input via a finger 208 of the user. In addition, the user flicks the digital object 204 from a first location to a particular edge region (e.g., edge region 206c) of the one or more edge regions (e.g., edge regions 206a-206c).

The movement of the input gesture from the user can end at the edge region. For example, the movement by finger 208 can end upon reaching an outer edge (e.g., an edge of the outer circle of edge region 206c). Alternatively, or in addition, the movement of the input gesture can continue after the edge region has been reached (e.g., continue through the concentric circles of edge region 206c).

Digital object 204 on electronic device 202 can be transferred (e.g., shared with) any of electronic devices 210a, 210b or 210c. For example, digital object 204 can correspond to any type of data on electronic device 202, including, but not limited to text, an image, a file, an address (e.g., URL), a request, or an instruction. Although digital object 204 is depicted as a circle, digital object is not limited to such. For example, digital object 204 can be depicted by one or more of a shape, an image, text, or any other visual indicator representing the object.

In response to the input gesture, electronic device 202 sends digital object 204 to the other device. In the example of FIG. 2, electronic device 202a sends digital object 204 to electronic device 210c, in response to the user's input which dragged digital object 204 from its first location towards edge region 206c.

An action can be designated in association with the digital object, and this associated action can also be sent to electronic device 210c. The action can be designated based on the data type (e.g., file, image, driving directions) of the digital object. For example, if the digital object is a file (e.g., an image file, a document) the associated action can be defined to save the file in a specified location (e.g., a directory) associated with electronic device 210c. In another example, the digital object can correspond to driving directions, and the associated action can be to automatically load the destination in a navigation application. Thus, when electronic device 210c receives a copy of the web page driving directions, electronic device 210c can automatically load the destination into a navigation application on the electronic device 210c.

It should be noted that the subject technology is not limited to transferring the digital object to another device (e.g., electronic devices 210a-210c), and can also provide for transferring the digital object to a service. Such a service can include, but is not limited to an on-line data storage service, a social networking service, a mapping service, or a search engine service. The service can be hosted on a separate server. In this regard, the user can designate an edge region of the display of electronic device 202 to be associated with the service, and the digital object and indication of any associated actions can be transferred to (e.g., shared with) that service.

In example aspects, the sharing of the digital object can correspond to a client-server network environment (e.g., a cloud computing environment). For example, the sending of the digital object can include transmitting the digital object to a server (not shown), which is configured to send the digital object to the other device or service. The server can be configured to designate an action in association with the digital object, and to send the digital object and an indication of the associated action to the target device (e.g., electronic device 210a-210c) or service. The target device (e.g., electronic device 210c) or service can be configured to receive the digital object and the indication of the associated action, and to perform the action associated with the digital object when the digital object is received. In this regard, each of the computing devices (e.g., electronic devices 202, 210a-210c, the server) can include the appropriate interfaces for sending and receiving the digital object and the indication of the associated action.

In other aspects, the sharing of the digital object can correspond to a peer-to-peer environment, where the sending of the digital object does not require the use of a server. For example, electronic device 202 can itself designate an action in association with the digital object, and can send the digital object and an indication of the associated action to the target device (e.g., electronic device 210c) or service. For example, the digital object and indication of the associated action can be sent via Bluetooth or Wi-Fi. The target device (e.g., electronic device 210c) or service can be configured to receive the digital object and the indication of the associated action, and to perform the action associated with the digital object when the digital object is received. Each of the computing devices (e.g., electronic devices 202, 210a-210c) can include the appropriate interfaces for sending and receiving the digital object and the indication of the associated action.

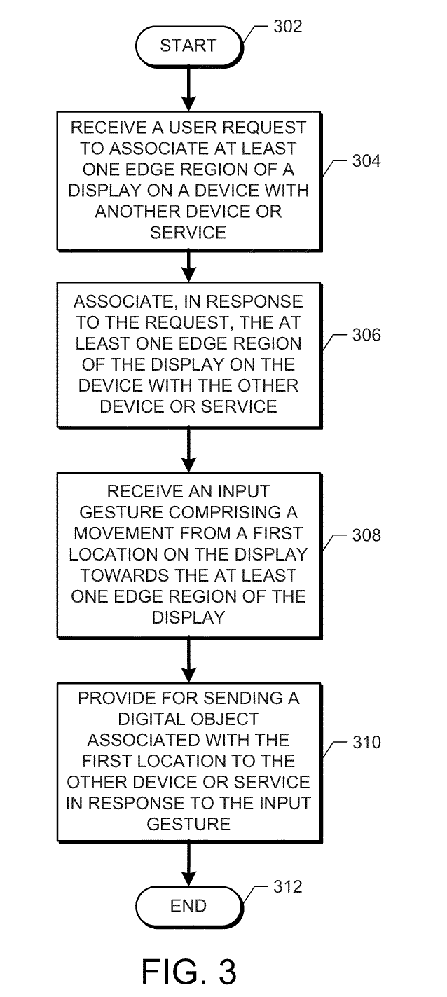

FIG. 3 illustrates an example process by which a digital object on a device is shared with another device or service. Following start block 302, a user request to associate at least one edge region of a display on a device with another device or service is received at step 304.

At step 306, in response to the request, the at least one edge region of the display on the device is associated with the other device or service. The edge region can include an edge of the display or a corner of the display. The display can include a graphical component indicating the other device or service associated with the at least one edge region. The at least one edge region can include multiple edge regions, each of which is associated with a respective other device or service.

At step 308, an input gesture comprising a movement from a first location on the display towards the at least one edge region of the display is received. The movement of the input gesture can end at the at least one edge region. Alternatively, or in addition, the input gesture can continue after the at least one edge region has been reached. The input gesture can include at least one of a touch input or a mouse input.

At step 310, in response to the input gesture, a digital object associated with the first location is sent to the other device or service. The sending can include transmitting the digital object associated with the first location to a server which is configured to send the digital object to the other device or service. The server can further be configured to designate an action in association with the digital object, and to send the digital object and an indication of the associated action to the other device or service. The other device or service can be configured to receive the digital object and the indication of the associated action, and to perform the action associated with the digital object when the digital object is received. The process then ends at end block 312.

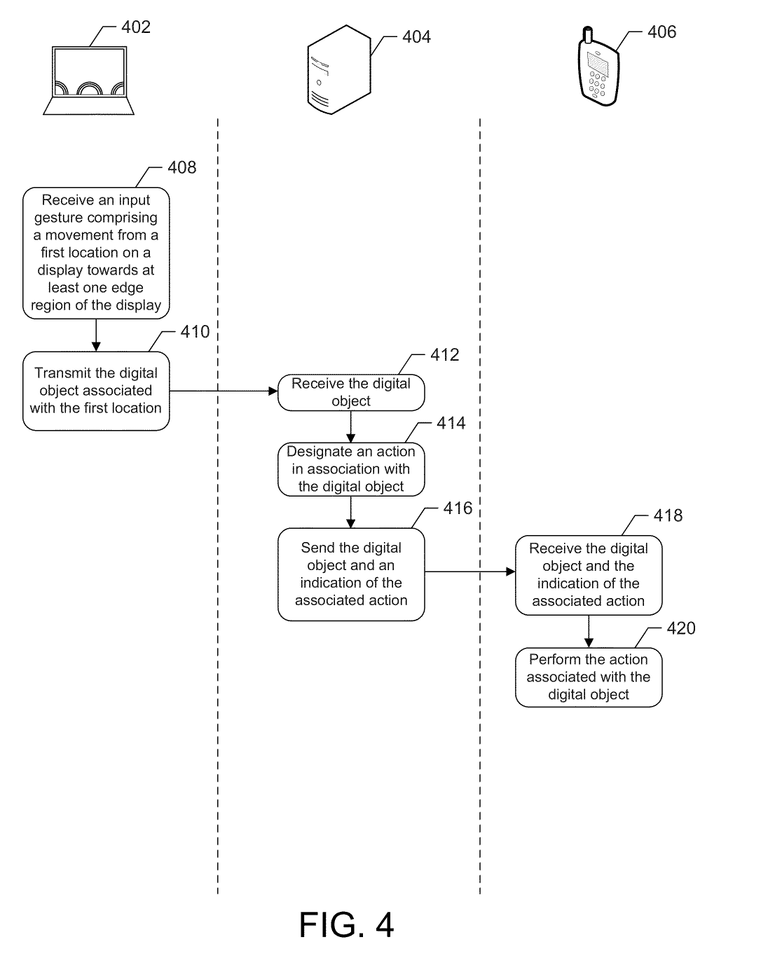

FIG. 4 illustrates an example process by which a digital object on a device is shared with another device or service via a server. In the example of FIG. 4, a digital object on an electronic device 402 is sent to (e.g., shared with) an electronic device 406 via a server 404. For example, electronic device 402 can correspond to any of electronic devices 102-106 of FIG. 1 (or to electronic device 202 of FIG. 2), electronic device 406 can correspond to any of electronic devices 102-106 (or to any of electronic devices 210a-210c), and server 404 can correspond to server 110.

Electronic devices 402 and 406 can be computing devices such as laptop or desktop computers, smartphones, PDAs, portable media players, tablet computers, or other appropriate computing devices. In the example of FIG. 4, electronic device 402 is depicted as a laptop, and electronic device 406 is depicted as a smartphone.

At step 408, electronic device 402 receives an input gesture (e.g., mouse input, keyboard input, touch input) comprising a movement from a first location on a display (e.g., a monitor display, a touchscreen display) towards at least one edge region of the display. At steps 410-412, electronic device 402 transmits the digital object associated with the first location to server 404, and server 404 receives the digital object.

At step 414, server 404 designates an action in association with the digital object. At steps 416-418, server 404 sends the digital object and an indication of the associated action to electronic device 406, and electronic device 406 receives the digital object and the indication of the associated action. At step 420, electronic device 406 performs the action associated with the digital object.

It should be noted that the subject technology is not limited to transferring the digital object to another device (e.g., electronic devices 406), and can also provide for transferring the digital object to a service. Such services include, but are not limited to an on-line data storage service, a social networking service, a mapping service, or a search engine service. For example, such a service can be hosted on a separate server. In this regard, the user can designate an edge region of the display of electronic device 202 to be associated with the service, and the digital object and indication of any associated actions can be transferred to (e.g., shared with) that service.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

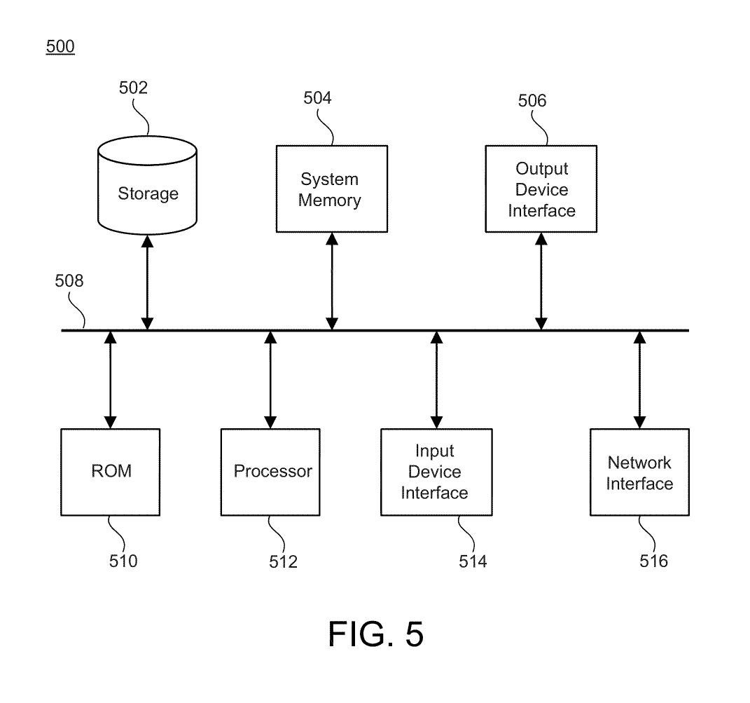

FIG. 5 conceptually illustrates an electronic system with which some implementations of the subject technology are implemented. Electronic system 500 can be a computer, phone, PDA, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for sharing a digital object in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for sharing a digital object on a device with another device or service, the method comprising:
receiving a user request to associate at least one edge region of a display on a device with another device or service;
associating, in response to the request, the at least one edge region of the display on the device with the other device or service;
receiving an input gesture comprising a movement from a first location on the display towards the at least one edge region of the display; and
providing for sending a digital object associated with the first location to the other device or service in response to the input gesture.

2. The method of claim 1, wherein the movement of the input gesture ends at the at least one edge region.

3. The method of claim 1, wherein the movement of the input gesture continues after the at least one edge region has been reached.

4. The method of claim 1, wherein the edge region comprises an edge of the display or a corner of the display.

5. The method of claim 1, wherein the display includes a graphical component indicating the other device or service associated with the at least one edge region.

6. The method of claim 1, wherein the input gesture comprises at least one of a touch input or a mouse input.

7. The method of claim 1, wherein the sending comprises transmitting the digital object associated with the first location to a server which is configured to send the digital object to the other device or service.

8. The method of claim 7, wherein the server is further configured to designate an action in association with the digital object, and to send the digital object and an indication of the associated action to the other device or service.

9. The method of claim 8, wherein the other device or service is configured receive the digital object and the indication of the associated action, and to perform the action associated with the digital object when the digital object is received.

10. The method of claim 1, wherein the at least one edge region comprises multiple edge regions, each of which is associated with a respective other device or service.

11. A system for sharing a digital object on a device with another device or service, the system comprising:
one or more processors; and
a machine-readable medium comprising instructions stored therein, which when executed by the processors, cause the processors to perform operations comprising:
associating at least one edge region of a display on a device with another device or service;
receiving an input gesture comprising a movement from a first location on the display towards the at least one edge region of the display; and
providing for sending a digital object associated with the first location to the other device or service in response to the input gesture.

12. The system of claim 11, the operations further comprising:
receiving, prior to the associating, a user request to associate the at least one edge region of the display on the device with the other device or service,
wherein the associating is in response to the received request.

13. The system of claim 11, wherein the movement of the input gesture ends at the at least one edge region.

14. The system of claim 11, wherein the movement of the input gesture continues after the at least one edge region has been reached.

15. The system of claim 11, wherein the edge region comprises an edge of the display or a corner of the display.

16. The system of claim 11, wherein the display includes a graphical component indicating the other device or service associated with the at least one edge region.

17. The system of claim 11, wherein the input gesture comprises at least one of a touch input or a mouse input.

18. A machine-readable medium comprising instructions stored therein, which when executed by a system, cause the system to perform operations comprising:
receiving a user request to associate at least one edge region of a display on a device with another device or service, wherein the edge region comprises an edge of the display or a corner of the display;
associating, in response to the request, the at least one edge region of the display on the device with the other device or service;
receiving an input gesture comprising a movement from a first location on the display towards the at least one edge region of the display; and
providing for sending a digital object associated with the first location to the other device or service in response to the input gesture.

19. The machine-readable medium of claim 18, wherein the movement of the input gesture ends at the at least one edge region.

20. The machine-readable medium of claim 18, wherein the movement of the input gesture continues after the at least one edge region has been reached.
